(19) United States
(12) Patent Application Publication
(10) Pub. No.: US 2007/0234598 A1
(43) Pub. Date: Oct. 11, 2007

(54) Sports memorabilia article

(75) Inventor: Terry Goldstein, Massapequa, NY (US)

Correspondence Address: F. CHAU & ASSOCIATES, LLC, 130 WOODBURY ROAD, WOODBURY, NY, 11797, US

(73) Assignee: New York Islanders Hockey Club, LP

(21) Appl. No.: 11/396,774

(22) Filed: Apr. 3, 2006

(51) Int. Cl. G09F 3/02

(52) U.S. Cl. 40/27.5

(57) ABSTRACT

A sports memorabilia article is provided. The sports memorabilia article includes a portion of material comprised of one of plexiglass or glass. The portion of material is of the type which is used as part of a spectator protective wall to surround areas of an ice hockey rink during an ice hockey game. Moreover, the sports memorabilia article further includes an indentifying indicia regarding ice hockey provided together with the portion of material.

### BACKGROUND OF THE INVENTION

1. Field of the Invention

The present invention relates a sports memorabilia article, and more particularly to a sports memorabilia article which was used during an actual sporting event, e.g. a professional ice hockey game or a professional basketball game.

2. Description of the Related Art

Collecting sports-related memorabilia has long been a popular hobby or diversion, which can also reap financial rewards to its collectors. Thus, there exists a strong demand for such articles. Generally, collectable sports memorabilia can comprise a variety of different items related to sports and also to notable sports individuals. For example, a collectable item may be a program, baseball trading cards, football trading cards, hockey trading cards, basketball trading cards, a poster, sporting apparel or items associated with a sport, such as a baseball, a bat, a hockey stick, hockey puck or other item of equipment.

Examples of sports memorabilia items are discussed in U.S. Pat. No. 6,973,747 B2 and U.S. Pat. No. 6,920,709 B2. U.S. Pat. No. 6,920,709 B2 purports to disclose an article of sports memorabilia having collectable attractiveness attributes wherein common and personalized attributes are displayed on the article such as a home plate, tee shirt, glass or picture. The common attributes indicate the name of a stadium or field, a team, a team player striking or kicking a sport ball such as a baseball, football or soccer ball. The personalized attributes indicate the name and address of a person or entity for whom the article is personalized, and the number of feet between the stadium or field, or home plate or other location on the field, and the address of the person for whom the article is personalized.

Further, U.S. Pat. No. 6,973,747 B2 purports to disclose a sports memorabilia apparatus comprising a hockey puck comprising a cavity therein. A medallion comprised of a precious metal or other material is provided within the cavity. Indicia appear on the medallion embossed by conventional minting or coining technology.

However, while owning a unique or rare item of sports memorabilia may give some collectors a certain sense of pleasure or fulfillment, it is not of the same magnitude as owning an article or item that was actually used during a professional sporting event. Sports memorabilia articles used during an actual game are not just collectible items but also a piece of history.

Thus, there is a need for a sports memorabilia item or article which was used during an actual sporting event.

### SUMMARY OF THE INVENTION

According to an exemplary embodiment of the present invention, a sports memorabilia article is provided. The sports memorabilia article includes a portion of material comprised of one of plexiglass or glass. The portion of material is of the type which is used as part of a spectator protective wall to surround areas of an ice hockey rink during an ice hockey game. Moreover, the sports memorabilia article further includes an indentifying indicia regarding ice hockey provided together with the portion of material.

According to an exemplary embodiment of the present invention, a game used sports memorabilia article is provided. The memorabilia article includes a plexiglass piece obtained from a plexiglass board which was used during a professional sporting event. In addition, the memorabilia article further includes one of an etching and an engraving of information regarding the professional sporting event located on a surface of the plexiglass piece. The information includes at least one of a name and a logo of the professional sports team of the sports arena from which the plexiglass piece was obtained.

According to another exemplary embodiment, a method for forming a sports memorabilia article is provided. The method includes obtaining a portion of material comprised of one of plexiglass and glass. The portion of material is of the type which is used as part of a spectator protective wall to surround areas of an ice hockey rink during an ice hockey game. Additionally, the method includes providing indentifying indicia regarding ice hockey together with the portion of material.

### BRIEF DESCRIPTION OF THE DRAWINGS

FIG. 1 illustrates a sports memorabilia article according to an exemplary embodiment of the present invention;

FIG. 2 illustrates an ice hockey rink wherein a professional ice hockey game may be played; and

FIG. 3 illustrates a sports memorabilia article according to an exemplary embodiment of the present invention.

### DETAILED DESCRIPTION OF THE EXEMPLARY EMBODIMENTS OF THE INVENTION

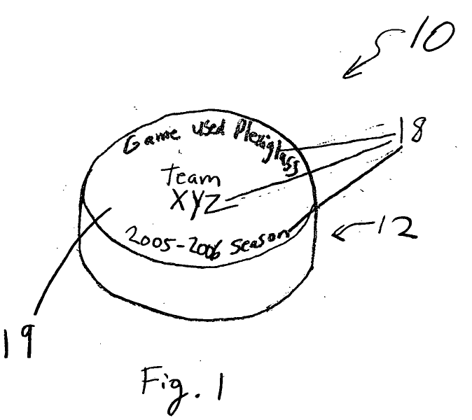

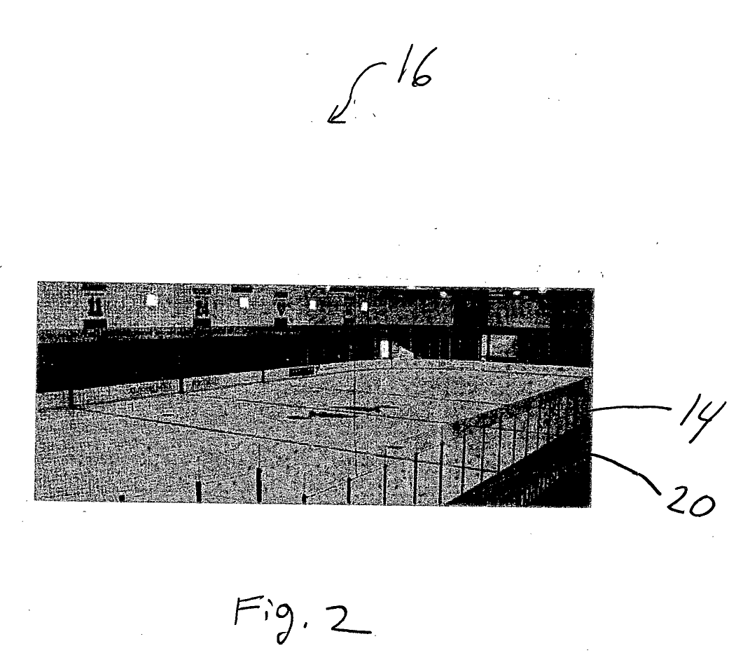

FIG. 1 illustrates a sports memorabilia article 10 formed from materials obtained from an actual sporting event in accordance with an exemplary embodiment of the present invention. In the present exemplary embodiment of FIG. 1, the sports memorabilia article 10 includes a transparent portion or piece 12 comprised of plexiglass material which was cut or removed from a transparent spectator protective wall 14 (see FIG. 2) comprised of plexiglass material used to surround areas of an ice hockey rink 16 during an ice hockey game (e.g. a professional ice hockey game) for preventing hockey pucks from flying into the stands and injuring spectators. Moreover, the game used sports memorabilia article 10 further includes indentifying indicia 18 or information disposed on the plexiglass piece 12 which provides information regarding a particular professional ice hockey game or event.

The plexiglass material of this exemplary embodiment is also referred to by its chemical name of polymethyl methacrylate (PMMA). Alternatively, the portion or piece 12 may be obtained from protective walls comprised of any other materials known in the art of ice hockey including but not limited to glass.

As shown in FIG. 1, the piece 12 of the protective wall 14 of the present exemplary embodiment, is a small circularly shaped disc, similar in appearance to an ice hockey puck. However, the piece 12 of the protective wall 14 may also be provided in other shapes including but not limited to square or rectangular shapes. Furthermore, the piece 12 of the spectator protective wall 14 may also be provided in varying dimensions, e.g. varying sizes, lengths and thicknesses.

Now, the role of the protective wall 12 during an ice hockey game will be further described below.

For example, as shown in FIG. 2, ice hockey rinks 16 wherein professional ice hockey games may be played are typically rectangularly shaped with rounded corners and surrounded by a wall approximately 40 inches high called the boards 20. Moreover, as mentioned above, the height of the boards 20 are generally extended with spectator protective plexiglass walls 14 or spectator protective glass walls to prevent hockey pucks from leaving the playing surface and injuring spectators.

The plexiglass protective walls 14 also serve another role during an ice hockey game. For instance, these protective walls 14 serve as a surface in which hockeys players having control of the puck are body checked or hit into by an opposing hockey player(s) seeking to obtain possession of this puck. When the hit or check is of a substantial force or magnitude, areas of the protective plexiglass may become damaged (e.g. may crack), or in the case of glass material may shatter. Instead of discarding the cracked, broken and/or damaged spectator protective wall 14, the present exemplary embodiments provide the benefit of having this damaged area of the game used spectator protective plexiglass wall 14 or spectator protective glass wall recycled to be sold as a game used sports memorabilia item. It is further noted that the exemplary embodiments of the present invention may also be applied to spectator protective plexiglass walls 14 or spectator protective glass walls 14 which have not been damaged during an ice hockey game.

Additionally, as mentioned above, the sports memorabilia article 10 of the present exemplary embodiment also includes identifying indicia 18 provided on the plexiglass piece 12 which provides information regarding the ice hockey sporting game or event. For example, as shown, in FIG. 1, the identifying indicia 18 includes the home team's name and/or logo (e.g. team XYZ), the specific season (e.g. 2005-2006) and the phrase “game used plexiglass” which are all located on the top side 19 of the plexiglass piece 12. Other indentifying indicia may also be placed thereon in addition to or in lieu of the above indentifying indicia, including but not limited to all of the teams names/logos involved in the particular sporting event, the name(s) of the player or players involved in the collision into the spectator protective wall 14 resulting in the cracks or damage thereto, the date of the game or event, pictures, sketches, photos, expressions and/or slogans.

The above indentifying indicia 18 may be etched or engraved on the plexiglass piece 12. In the present exemplary embodiment, computer etching or computer engraving techniques known in the art are used for placing the indentifying indicia 18 on the top side 19 of the plexiglass piece 12. However, other techniques known in the art may also be used to place the indentifying indicia 18 on any or all sides of the plexiglass portion 12. For example, in other embodiments instead of being engraved or etched, the indentifying indicia 18 may instead be affixed to the plexiglass piece 12 by means known in the art such as e.g. via stickers or labels. Further, in still other embodiments of the invention, instead of being engraved or etched, the identifying indicia 18 may instead be provided on an outer cover such e.g., wrapping paper, a casing, or box cover which encases/encloses the plexiglass piece 12.

A method for preparing and using the sports memorabilia article 10 in accordance with the exemplary embodiment of the present invention depicted in FIG. 1 will be described below, but is by way of example only and is in no way meant to limit the scope of the exemplary embodiments of the invention.

First, a portion or piece of plexiglass 12 is removed from a spectator protective wall 14 which was damaged during a professional ice hockey game. The plexiglass piece 12 is removed by being cut out from the protective wall using tools or machinery known in the art to form one or more pieces (e.g. one or more small pieces) of plexiglass having cosmetic imperfections (e.g. damage, scratches or cracks therein). The plexiglass piece 12 or pieces may be cut out from the protective wall 14 into different shapes as desired (e.g. circular shaped pieces or square shaped pieces). For example, in the embodiment of FIG. 1, the plexiglass portion or piece 12 has been cut out into a small circular shaped piece of plexiglass. Moreover, the plexiglass piece 12 may be shaped prior to after removal of this piece from the spectator protective wall. Furthermore, in other embodiments, the small plexiglass piece 12 does not have any cracks, cosmetic imperfections, scratches or any other damage thereto.

Next, an etching or engraving technique known the art including but not limited to computer etching or computer engraving is used to etch or engrave indentifying indicia 18 regarding a particular ice hockey sporting event on the top side 19 of the plexiglass piece 12 removed from the plexiglass spectator protective wall 14. For example, as shown, in FIG. 1, indentifying indicia 18 such as the home team's name and/or logo (e.g. team XYZ), the specific season (e.g. 2005-2006) and the phrase “game used plexiglass” are engraved on the top side 19 of the plexiglass piece 12 removed from the protective wall 14. Other identifying indicia may also be placed on the plexiglass piece 12 in addition to or in lieu of the above information. There is no required order for performing the removal and etching/engraving steps in forming the memorabilia article 10. For instance, in other embodiments, the engraving or etching of the identifying indicia may be performed prior to removal of the plexiglass piece or pieces from the protective wall.

After preparing the game used plexiglass sports memorabilia article 10 as described above, this memorabilia article 10 is then provided for sale at different locations, including but not limited to professional ice hockey arenas, sporting good stores, and other types of stores which sell sports memorabilia. A user may then view the above plexiglass sports memorabilia article 10 and purchase it based upon, for example, his or her preference for a particular ice hockey team.

It also noted that in alternate embodiments of the present invention, the sports memorabilia articles may be formed using the same plexiglass or glass material mentioned above, except that in these alternate embodiments the plexiglass or glass material has never been used during an actual ice hockey game and/or was not used as part of a protective spectator wall in an ice hockey arena. In addition, in these alternative embodiments, the indentifying indicia may be placed on these plexiglass or glass pieces in the same manner as discussed for the previous embodiment depicted in FIG. 1. Moreover, the indentifying indicia may include, e.g., the name and logo of an ice hockey team and the specific ice hockey season.

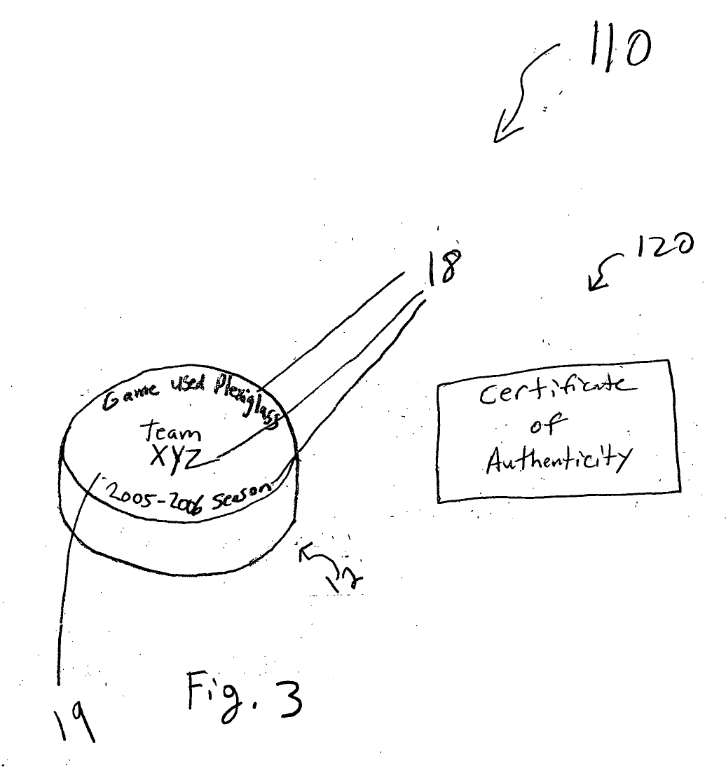

FIG. 3 illustrates a sports memorabilia article 110 according another exemplary embodiment of the present invention. The sports memorabilia article of the present exemplary embodiment is essentially the same as the sports memorabilia article 10 of the embodiment depicted in FIG. 1, except that the sports memorabilia article 110 the present exemplary embodiment further includes a certificate of authenticity 120 accompanying the memorabilia article 110. The certificate of authenticity 120 demonstrates that the sports memorabilia article 110 is an authentic and genuine product. The certificate of authenticity 120 may be any form known in the art such as, for example, a seal or a small sticker on the memorabilia article, a separate document or a separate card, accompanying the memorabilia article. For instance, as shown in FIG. 3, the certificate of authenticity 120 in this exemplary embodiment is in the form of a card accompanying the memorabilia article 110. Furthermore, the sports memorabilia article 110 of this exemplary embodiment has identifying indicia 18 provided on a top side of the plexiglass piece 12 in the same manner described for the exemplary embodiment of FIG. 1.

Although only ice hockey has been discussed herein, the exemplary embodiments of the present invention may also be applied to other sports as well. For example, a sports memorabilia article can also be manufactured in accordance with the exemplary embodiments of the present invention from a portion or piece of a transparent plexiglass or glass backboard of a basketball hoop used in a basketball game in a similar fashion as the sports memorabilia articles of the embodiments depicted in FIGS. 1 and 3 were manufactured.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A sports memorabilia article comprising:
a portion of material comprised of one of plexiglass or glass, said portion of material being of the type which is used as part of a spectator protective wall to surround areas of an ice hockey rink during an ice hockey game; and
indentifying indicia regarding ice hockey provided together with the portion of material.

2. The memorabilia article of claim 1, wherein the portion of material is comprised of plexiglass, and said portion of plexiglass material being obtained from a spectator protective wall used during an actual ice hockey game.

3. The memorabilia article of claim 2, wherein the portion of material comprised of plexiglass is obtained from an area of the spectator protective wall which was damaged during the ice hockey game as a result of a collision between one or more ice hockey players or objects into the spectator protective wall.

4. The memorabilia article of claim 1, wherein the indentifying indicia comprises one of an etching of information regarding a professional ice hockey game located on a surface of the portion of material or an engraving of information regarding a professional ice hockey game located on a surface of the portion of material.

5. The memorabilia article of claim 4, wherein the information of the indentifying indicia comprises at least one of a name or a logo of a professional ice hockey team of the ice hockey rink from which the plexiglass portion of material was obtained.

6. The memorabilia article of claim 1, wherein said portion of material has a substantially circular shape.

7. The memorabilia article of claim 4, wherein the information of the identifying indicia comprises the name and the logo of the professional ice hockey team of the ice skating rink from which the portion of material from the protective wall was obtained, the season in which the spectator protective wall was used during the professional ice hockey game and text on the portion of material indicating that the portion of material was used as part of the protective wall during the ice hockey game.

8. The memorabilia article of claim 4, further comprises a certificate of authenticity provided with the portion of material which certifies that the memorabilia article is authentic and genuine.

9. The memorabilia article of claim 8, wherein the certificate of authenticity comprises one of a seal on the memorabilia article, a sticker on the memorabilia article, a separate document accompanying the article or a separate card accompanying the memorabilia article.

10. A game used sports memorabilia article comprising:
a plexiglass piece obtained from a plexiglass board which was used during a sporting event;
one of an etching or an engraving of information regarding the sporting event located on a surface of the plexiglass piece, said information comprising at least one of a name or a logo of a professional sports team of a sports arena from which the plexiglass piece was obtained.

11. The game used sports memorabilia article of claim 10, wherein the sporting event is a professional ice hockey game and the plexiglass board was used as a spectator protective wall during the professional ice hockey game.

12. The game used sports memorabilia article of claim 11, wherein the spectator protective wall from which the plexiglass piece was obtained is substantially transparent.

13. The game used sports memorabilia article of claim 11, wherein the plexiglass piece is obtained from an area of the spectator protective wall which was damaged during the ice hockey game as a result of a collision between one or more ice hockey players or objects into the spectator protective wall.

14. The memorabilia article of claim 11, wherein said plexiglass piece has a shape which comprises one of a substantially circular shape or a substantially square shape.

15. The memorabilia article of claim 11, wherein the etching of the information is a computer etching or engraving of the information regarding the professional ice hockey game.

16. The memorabilia article of claim 10, further comprises a certificate of authenticity provided with the plexiglass piece which certifies that the memorabilia article is authentic and genuine.

17. The memorabilia article of claim 10, wherein the sporting event is a professional basketball game and the plexiglass board was used as a backboard of a basketball hoop during the professional basketball game.

18. A method for forming a sports memorabilia article comprising:
obtaining a portion of material comprised of one of plexiglass and glass, said portion of material being of the type which may be used as part of a spectator protective wall to surround areas of an ice hockey rink during an ice hockey game; and
providing indentifying indicia regarding ice hockey together with the portion of material.

19. The method of claim 18, wherein said portion of material is comprised of plexiglass and obtained from a spectator protective wall used during a professional ice hockey game to surround areas of an ice hockey rink.

20. The method of claim 19, wherein said portion of material comprising plexiglass is obtained by cutting the spectator protective wall into the shape of one of a circular shape or a square shape.

21. The method of claim 20, wherein said step of providing the indentifying indicia comprises one of using a computer etching method and a computer engraving method for providing the indentifying indicia on a surface of the portion of material, said indentifying indicia comprising at least one of a name and a logo of the professional ice hockey team of the ice hockey rink from which the plexiglass piece was obtained.
